(19) United States
(12) Patent Application Publication
(10) Pub. No.: US 2014/0223878 A1
(43) Pub. Date: Aug. 14, 2014

(54) Lawn Mower Assemblies

(71) Applicant: Robert Sassone, Norwalk, CT (US)

(72) Inventor: Robert Sassone, Norwalk, CT (US)

(21) Appl. No.: 14/171,524

(22) Filed: Feb. 3, 2014

Related U.S. Application Data
(60) Provisional application No. 61/762,375, filed on Feb. 8, 2013.

(51) Int. Cl. A01D 34/00

(52) U.S. Cl. CPC A01D 34/00
USPC 56/320.1

(57) ABSTRACT

lawn mower designs are provided that enhance the efficiency and/or flexibility of use. In a first embodiment, a lawn mower is provided that includes at least one side/wing mowing deck that is movable relative to the main mower deck in a substantially horizontal plane. Thus, the movably mounted side/wing mowing deck(s) may be repositioned relative to the main mower deck based on a user's desires, e.g., based on the size and/or geometry of the lawn/yard being mowed. In a second embodiment, a swivel joint is provided between a handle assembly and lawn mower deck to facilitate utilization of the disclosed lawn mower. The handle assembly may include a locking mechanism that permits the handle assembly to be fixedly positioned relative to the lawn mower deck. Release of the locking mechanism permits repositioning of the handle assembly relative to the lawn mower deck, e.g., to facilitate navigation of the lawn mower deck relative to lawn/yard features and/or geometries.

### CROSS-REFERENCE TO RELATED APPLICATION

The present application claims priority benefit to a co-pending provisional patent application entitled “Improved Lawn Mower Assemblies,” which was filed on Feb. 8, 2014, and assigned Ser. No. 61/762,375. The entire content of the foregoing provisional application is incorporated herein by reference.

### BACKGROUND

1. Technical Field

The present disclosure is directed to lawn mower designs that enhance the efficiency and/or flexibility of use. More particularly, the present disclosure is directed to lawn mower designs that facilitate cutting operations relative to varying lawn/yard layouts and geometries.

2. Background Art

Lawn mowers vary in design and operation. For example, different sources of energy may be utilized in driving the cutting blades associated with lawn mowers, including manually-powered lawn mowers, gasoline-powered lawn mowers and electrically-powered lawn mowers. Different energy sources may also be utilized in advancing the lawn mower across a lawn/yard, e.g., manual power and/or drive assemblies powered by gasoline or electricity. In addition, lawn mowers are available that permit the user to ride the lawn mower assembly, whereas other lawn mowers require the user to walk with the lawn mower (generally behind the lawn mower). The design and operation of lawn mower equipment also vary based on the nature of use, e.g., residential lawn mowers and commercial lawn mowers. Thus, lawn mower equipment is generally selected based on its intended use, user preference and/or associated cost considerations.

As is well known, lawn mowers are designed to power one or more mower blades to cut grass (or other vegetation) to a desired height. Generally, power directed to the mower blade(s) cause the blades to rotate, thereby cutting the grass. The cut grass may be exhausted from the rear or side of the lawn mower, and may be freely dispersed to the environment, collected for subsequent disposal, or mulched prior to release to the environment.

Some lawn mowers—particularly commercial lawn mowers—are provided with multiple mower blades. Indeed, lawn mower assemblies may be provided that are adapted to be towed behind a tractor or other type of towing vehicle. Typically, in instances where multiple mower blades are provided, the mower blades are rotatably mounted with respect to a mower deck. Overlap of the cutting swath of the individual blades may be provided to enhance the cutting performance of the multiple-blade mower.

Larger scale lawn mowers may increase the cutting region for a single pass across a lawn/yard by including a side deck on one or both sides of the central lawn mower assembly. The side deck(s) are generally adapted to be raised/lowered relative to the lawn/yard and to be engaged/disengaged relative to the central lawn mower assembly. For example, U.S. Patent Publication No. 2011/0277434 to Jackson et al. provides an integrated belt drive system that allows the side/wing mower decks to be raised and the belt drive systems to be automatically disengaged from the drive system. The side/wing mower decks in the Jackson '434 publication may be raised, i.e., pivoted vertically upward, and locked into place by removing a locking pin, raising the side/wing deck and then reinserting the locking pin into a second position to lock the side/wing deck into the raised position. In the second position, the blades are disengaged and no other action may be required on the operator's part to continue using the main deck to cut grass.

Despite efforts to date, a need remains for lawn mower designs that enhance the efficiency and/or flexibility of use. In addition, a need remains for lawn mower designs that facilitate cutting operations relative to varying lawn/yard layouts and geometries. These and other needs are satisfied by the lawn mower designs described herein.

### SUMMARY

According to the present disclosure, advantageous lawn mower designs are provided that enhance the efficiency and/or flexibility of use. In addition, the disclosed lawn mower designs facilitate cutting operations relative to varying lawn/yard layouts and geometries. In exemplary embodiments of the present disclosure, an advantageous lawn mower is provided that includes at least one side/wing mowing deck that is movable relative to the main mower deck in a substantially horizontal plane. Thus, the movably mounted side/wing mowing deck(s) may be repositioned relative to the main mower deck based on a user's desires, e.g., based on the size and/or geometry of the lawn/yard being mowed.

The movable side/wing deck(s) generally include one or more cutting blades that are rotatably mounted with respect thereto. The cutting blade(s) may be driven by a “dedicated” motor/engine associated with the side/wing deck or, through belt or other linkage systems, by a central motor/engine associated with the main mower deck. In either case, power to the motor(s)/engine(s) may be provided by known energy sources, e.g., by gasoline or electricity.

The disclosed lawn mower design generally supports multiple cutting widths as measured from side-to-side of the lawn mower. For example, the lawn mower may be provided with a centrally located main mower deck to which is movably engaged a pair of side/wing decks (one on each side). The side/wing decks are generally independently movable relative to the main mower deck. Thus, according to the present disclosure, a user is able to move one or both side/wing decks in a substantially horizontal plane relative to the main mower deck so as widen or narrow the overall cutting width of the disclosed lawn mower.

In a further advantageous lawn mower design according to the present disclosure, one or more swivel joints are provided between a handle assembly and lawn mower deck to facilitate utilization of the disclosed lawn mower. In exemplary embodiments of the present disclosure, a single swivel joint is mounted with respect to the lawn mower deck in a substantially central location. A handle assembly extends upward from the single swivel joint, thereby permitting a lawn mower user to navigate the lawn mower deck relative to the lawn/yard in an efficient and flexible manner. In exemplary embodiments of the present disclosure, the handle assembly includes a locking mechanism that permits the handle assembly to be fixedly positioned relative to the lawn mower deck. Release of the locking mechanism permits repositioning of the handle assembly relative to the lawn mower deck, e.g., to facilitate navigation of the lawn mower deck relative to lawn/yard features and/or geometries.

Additional features, functions and benefits associated with the disclosed lawn mower designs will be apparent from the description which follows, particularly when read in conjunction with the appended figures.

### BRIEF DESCRIPTION OF THE FIGURES

To assist those of skill in the art in making and using the disclosed lawn mower designs, reference is made to the accompanying figures, wherein:

FIG. 1 is a bottom schematic view of an exemplary lawn mower according to the present disclosure;

FIG. 2 is a top schematic view of an exemplary lawn mower that includes a plurality of independent motors according to the present disclosure;

FIG. 3 is a top schematic view of an alternative exemplary lawn mower that includes a single motor adapted to drive multiple cutting blades according to the present disclosure;

FIG. 4 is a top schematic view of an exemplary lawn mower with a first side/wing mowing deck horizontally pivoted relative to a main mower deck according to the present disclosure;

FIG. 5 is a top schematic view of an exemplary lawn mower with first and second side/wing mowing decks horizontally pivoted relative to a main mower deck according to the present disclosure;

FIG. 6 is a top schematic view of an exemplary lawn mower with first and second side/wing mowing decks horizontally pivoted to a greater extent as compared to FIG. 5 relative to a main mower deck according to the present disclosure;

FIG. 7 is a bottom view of an alternative lawn mower design according to the present disclosure;

FIG. 8 is a schematic top view of the alternative lawn mower design of FIG. 7 according to the present disclosure;

FIG. 9 is a perspective view of the alternative lawn mower design of FIGS. 7 and 8 according to the present disclosure;

FIG. 10 is a bottom view of a further alternative lawn mower design similar to the lawn mower of FIGS. 7-9 according to the present disclosure; and

FIG. 11 is a bottom view of an additional alternative lawn mower design similar to the lawn mowers of FIGS. 7-9 and FIG. 10 according to the present disclosure.

### DESCRIPTION OF EXEMPLARY EMBODIMENT(S)

As noted above, advantageous lawn mower designs are provided that enhance the efficiency and/or flexibility of use. The disclosed lawn mower designs offer many advantages, including specifically facilitating cutting operations relative to varying lawn/yard layouts and geometries. As noted previously, the disclosed lawn mower may be powered in various ways, e.g., by gasoline or electricity. In addition, the cutting height of the disclosed lawn mowers may be adjusted, e.g., by adjusting the wheel mountings relative to the lawn mower assembly as is known in the art.

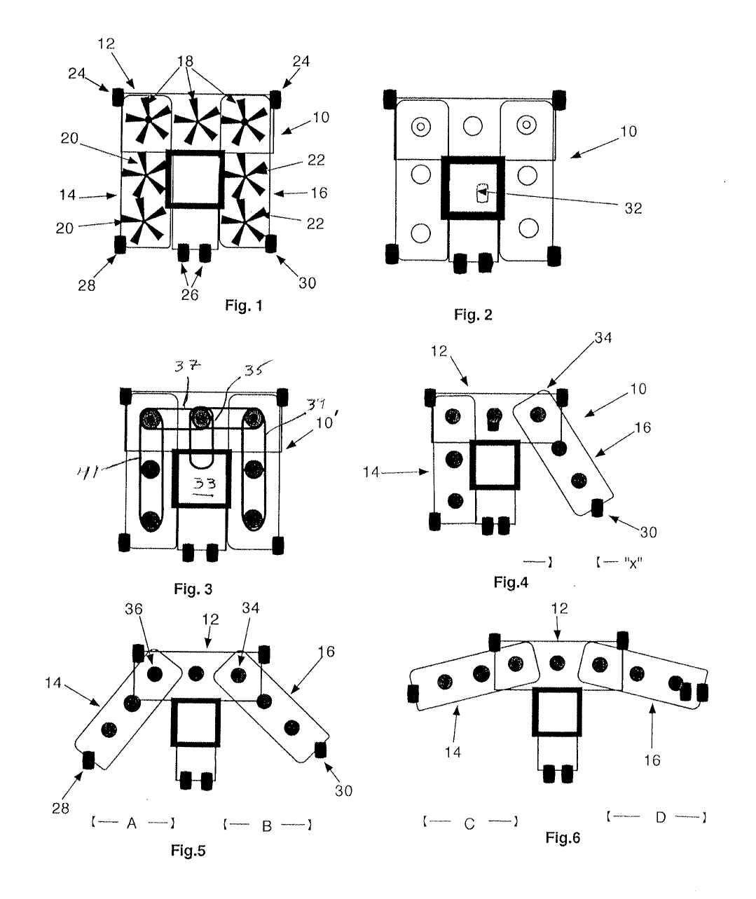

With reference to FIGS. 1-7, advantageous lawn mower designs are schematically depicted that include at least one side/wing mowing deck that is movable relative to the main mower deck in a substantially horizontal plane. With initial reference to FIG. 1, lawn mower 10 includes main mower deck 12, first side/wing mowing deck 14 and second side/wing mowing deck 16. Three mowing blades 18 are mounted with respect to main mower deck 12 and two additional mowing blades 20, 22 are mounted with respect to each of the first and second wing decks 14, 16, respectively. Front wheels 24 and rear wheels 26 are mounted with respect to main mower deck 12. First side wheel 28 is mounted with respect to first wing deck 14 and second side wheel 30 is mounted with respect to second wing deck 16.

As shown in FIG. 1, first and second wing decks 14, 16 are positioned in close adjacency to main mower deck 12. In this configuration, lawn mower 10 defines a substantially rectangular geometry when viewed from the top/bottom. In addition, front wheels 24 are in substantial alignment with first and second side wheels 28, 30, respectively. If advanced in this configuration with all mower blades active, lawn/yard regions that are passed over by the first and second wing decks 14, 16 will interact with multiple mower blades. It may be desirable to deactivate one or more of additional mowing blades 20, 22 in such circumstances, e.g., to limit operations to the mower blades associated with the main mower deck 12, but no need exists for such optional deactivation functionality according to the present disclosure.

With reference to the top schematic views of FIGS. 2 and 3, it is noted that main mower deck 12 supports components/assemblies associated with mower operations, e.g., battery 32, as is well known to persons skilled in the art. Of note, the lawn mower 10 schematically depicted in FIG. 2 includes independent motors associated with each of the mowing blades. By contrast, the lawn mower 10′ schematically depicted in FIG. 3 includes a single motor 33 that drives operations of each of the individual mowing blades thru belt systems 35, 37, 39, 41 or other linkages, as is also well known to persons skilled in the art. In subsequent figures, lawn mower designation “10” is utilized. However, it is to be understood that each of the additional figures may as easily have been described with reference to lawn mower 10′. Thus, the pivoting functionality described below has equal applicability to single and multiple motor implementations.

Turning to FIGS. 4-6, lawn mower 10 is schematically depicted with first and second wing decks 14, 16 in various positions relative to main mower deck 12. In particular, with reference to FIG. 4, first wing deck 14 remains in close adjacency to main mower deck 12, whereas second wing deck 16 has been pivoted relative to pivot joint 34 and in a substantially horizontal plane into an angular orientation (approximately 30°) relative to main mower deck 12. In this orientation, the overall width of the cutting region of lawn mower 10 is extended relative to such width in the non-pivoted orientation of FIGS. 1-3 by the distance “X”. In addition and as is apparent from FIG. 4, first and second wing decks 14, 16 may be adjusted individually to the extent desired by a user. Side wheel 30 is advantageously mounted with a swivel joint relative to second wing deck 16 so as to facilitate forward movement of lawn mower 10 with second wing deck 16 in an angular orientation relative to main mower deck 12. A locking mechanism may be provided to releasably lock the wing decks 14, 16 in desired orientations relative to main mower deck 12.

Turning to FIGS. 5 and 6, lawn mower 10 is schematically depicted with wing decks 14, 16 at differing angles relative to main mower deck 12. Thus, in FIG. 5, both first and second wing decks 14, 16 have been rotated in a substantially horizontal plane relative to pivot joints 34, 36 so as to assume angular orientations (approximately 45°) relative to main mower deck 12. Both side wheels 28, 30 are mounted with a swivel joint relative to the associated wing deck 14, 16, respectively, to facilitate movement of lawn mower 10. In the orientation of FIG. 5, the overall cutting region of lawn mower 10 is increased by a distance equal to “A”+“B” as compared to the non-angled orientation of FIGS. 1-3. In FIG. 6, wing decks 14, 16 are rotated outward in a substantially horizontal plane to a greater extent (approximately 85°) relative to main mower deck 12, thereby increasing the cutting region of lawn mower 10 by a distance equal to “C”+“D” as compared to the non-angled orientation of FIGS. 1-3.

Thus, the disclosed lawn mower designs of FIGS. 1-6 generally support multiple cutting widths as measured from side-to-side of the lawn mower. Indeed, as shown herein, the lawn mower may be provided with a centrally located main mower deck to which is movably engaged a pair of side/wing decks (one on each side). The side/wing decks are generally independently movable relative to the main mower deck. Thus, according to the present disclosure, a user is able to move one or both side/wing decks in a substantially horizontal plane relative to the main mower deck so as widen or narrow the overall cutting width of the disclosed lawn mower.

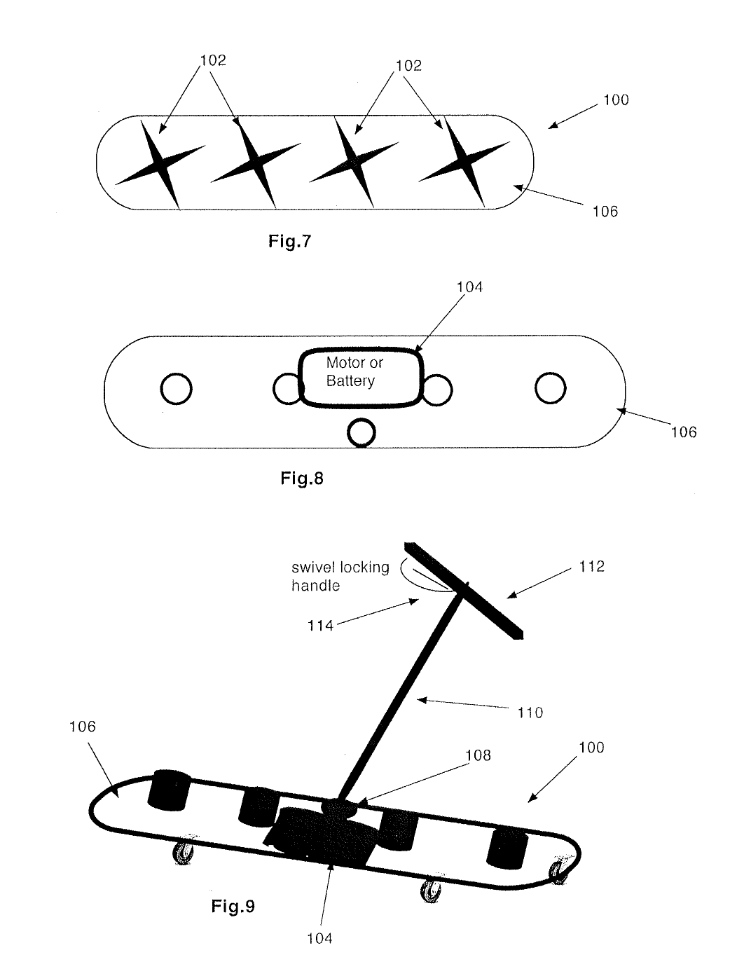

Turning to FIGS. 7-9, a further advantageous lawn mower design is schematically depicted according to the present disclosure. In general, the alternative lawn mower design of FIGS. 7-9 includes one or more swivel joints between a handle assembly and lawn mower deck to facilitate utilization of the disclosed lawn mower, e.g., based on the features and/or geometry of a lawn/yard.

With initial reference to FIG. 7, a bottom view of lawn mower 100 is provided that includes a plurality (four) cutting blades 102 mounted with respect to mower deck 106 in substantial linear alignment. The number and arrangement of cutting blades 102 is not limited by or to the illustrative implementation depicted in FIG. 7, as will be readily apparent to persons skilled in the art. As with the previously disclosed lawn mower 10, lawn mower 100 may be powered in various ways, e.g., by gasoline or electricity, and the cutting height of lawn mower 100 may be adjusted, e.g., by adjusting the wheel mountings relative to the lawn mower assembly as is known in the art. In addition, cutting blades 102 may be powered by a single motor or by multiple and/or individual motors.

Turning to FIG. 8, a top schematic view of lawn mower 100 shows the positioning of motor or battery 104 on the lawn mower deck 106. Additional components and/or assemblies may be mounted with respect to mower deck 106, as are known in the art.

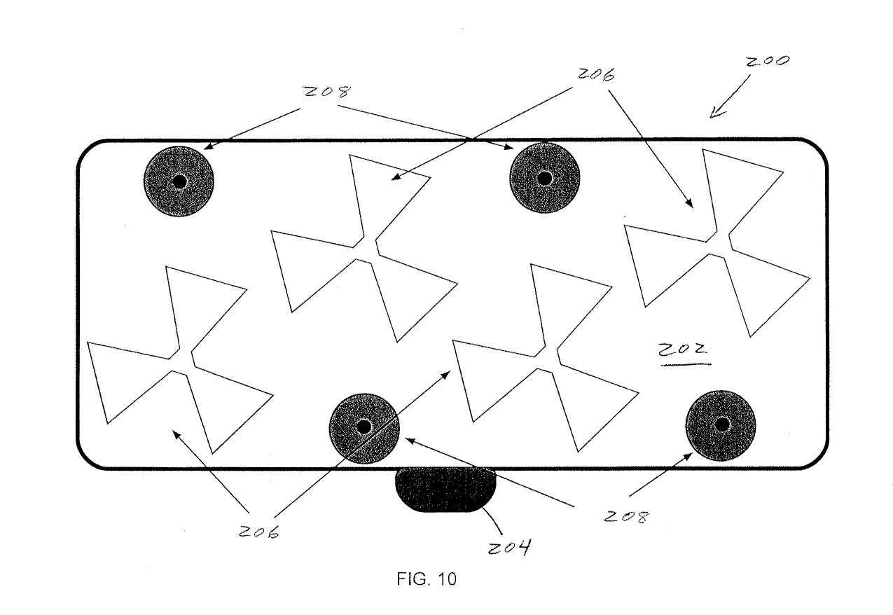

With reference to FIG. 9, a perspective schematic view of lawn mower 100 is provided wherein a swivel joint 108 facilitates angular and rotational motion of handle rod 110 and handle grip 112 relative to mower deck 106. Handle rod 110 and handle grip 112 together define a handle assembly. The swivel motion permitted by swivel joint 108 allows a user to navigate a wide variety of geometric paths while cutting a lawn/yard and/or storing lawn mower 100 between uses, as will be readily appreciated by persons skilled in the art. A locking mechanism 114 may be associated with the swivel functionality, e.g., based on a hand-operated breaking mechanism that detachably locks the handle rod 110 relative to the swivel joint 108.

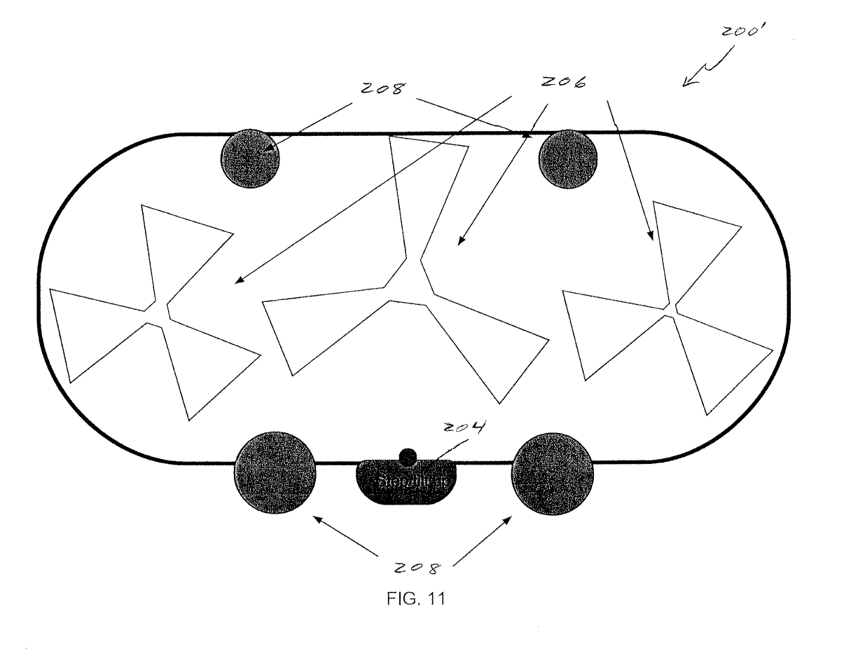

With reference to FIGS. 10 and 11, further exemplary lawn mower designs are provided according to the present disclosure. FIG. 10 schematically depicts an exemplary lawn mower 200 that includes a swivel handle (not pictured) that cooperates with lawn mower deck 202 at handle junction 204 that is positioned along the periphery of lawn mower deck 202. Lawn mower deck 202 supports four spaced cutting blades 206 and four wheels 208 positioned generally around the periphery thereof. Wheels 208 are generally mounted with respect to the lawn mower deck 202 so as to “swivel” in response to user interactions with the swivel handle. For example, wheels 208 may take the form of swivel casters that are adapted to be oriented to facilitate travel of lawn mower 200 in any direction.

Similarly, FIG. 11 schematically depicts a further exemplary lawn mower 200′ that includes a swivel handle (not pictured) that cooperates with lawn mower deck 212 at handle junction 214 that is positioned along the periphery of lawn mower deck 212. Lawn mower deck 212 supports three spaced cutting blades 216 and four wheels 218 positioned generally around the periphery thereof. Wheels 218 are generally mounted with respect to the lawn mower deck 212 so as to “swivel” in response to user interactions with the swivel handle. For example, wheels 218 may take the form of swivel casters that are adapted to be oriented to facilitate travel of lawn mower 200′ in any direction.

Thus, in exemplary embodiments of the present disclosure, a single swivel joint is mounted with respect to the lawn mower deck, e.g., in a substantially central location or along the periphery of the lawn mower deck. A handle assembly extends upward from the single swivel joint, thereby permitting a lawn mower user to navigate the lawn mower deck relative to the lawn/yard in an efficient and flexible manner.

Although specific embodiments have been illustrated and described herein, those of ordinary skill in the art will appreciate that the present disclosure is not limited by or to the disclosed embodiments. Rather, the disclosed embodiments are merely illustrative of potential implementations of the advantageous features and functions disclosed herein.

1. A lawn mower comprising:
a main mower deck; and
at least one side deck or wing deck;
wherein the at least one side deck or wing deck is pivotally mounted with respect to the main mower deck so as to permit angular rotation of the at least one side deck or wing deck relative to the main mower deck in a substantially horizontal plane.

2. The lawn mower of claim 1, wherein the at least one side deck or wing deck includes a first and a second side deck or wing deck, and wherein each of the first and the second side deck or wing deck is independently angularly movable relative to the main mower deck in a substantially horizontal plane.

3. The lawn mower of claim 1, further comprising at least one locking mechanism that is adapted to releasably lock the at least one side deck or wing deck relative to the main mower deck.

4. The lawn mower of claim 1, further comprising at least one cutting blade mounted with respect to the main mower deck and at least one cutting blade mounted with respect to the at least one side deck or wing deck.

5. The lawn mower of claim 4, wherein the at least one cutting blade mounted with respect to the main mower deck is commonly powered with the at least one cutting blade mounted with respect to the at least one side deck or wing deck.

6. The lawn mower of claim 4, wherein the at least one cutting blade mounted with respect to the main mower deck is independently powered relative to the at least one cutting blade mounted with respect to the at least one side deck or wing deck.

7. The lawn mower of claim 1, further comprising at least one wheel mounted with respect to the at least one side deck or wing deck with a swivel joint.

8. The lawn mower of claim 1, wherein the main mower deck and the at least one side deck or wing deck are adapted to be positioned in (i) a first relative position wherein the at least one side deck or wing deck is in close adjacency to the main mower deck, and (ii) a second relative position wherein the at least one side deck or wing deck is angled relative to the main mower deck.

9. The lawn mower of claim 8, wherein the main mower deck and the at least one side deck or wing deck are adapted to assume a plurality of angled positions.

10. The lawn mower of claim 8, further comprising a locking mechanism adapted to releasably lock the main mower deck and the at least one side deck or wing deck in a selected relative position.

11. A lawn mower comprising:
a main mower deck, and
a handle assembly,
wherein the handle assembly is mounted relative to the main mower deck by a swivel joint.

12. The lawn mower according to claim 11, further comprising a locking mechanism adapted to releasably lock the handle assembly in a fixed angular and rotational orientation relative to the main mower deck.

13. The lawn mower according to claim 11, further comprising a swivel joint mounted with respect to the main mower deck.

14. The lawn mower according to claim 13, wherein the handle assembly includes a handle rod that engages the swivel joint and a handle grip that is joined to or formed with the handle rod.

15. The lawn mower according to claim 11, further comprising a plurality of cutting blades mounted with respect to the main mower deck.

16. The lawn mower according to claim 11, further comprising a plurality of wheels mounted with respect to the main mower deck.

17. The lawn mower according to claim 16, wherein each of the plurality of wheels are mounted with respect to the main mower deck by a swivel joint.
